(19) United States
(12) Patent Application Publication
(10) Pub. No.: US 2024/0304932 A1
(43) Pub. Date: Sep. 12, 2024

(54) BATTERY PACK

(71) Applicant: Prime Planet Energy & Solutions, Inc., Tokyo (JP)

(72) Inventors: Naotake YOSHIDA, Himeji-shi (JP); Masaki FUKUDA, Kasai-shi (JP)

(21) Appl. No.: 18/442,102

(22) Filed: Feb. 15, 2024

(30) Foreign Application Priority Data
Mar. 7, 2023 (JP) 2023-034424

(51) Int. Cl. H01M 50/296; H01M 50/209

(52) U.S. Cl. CPC H01M 50/296; H01M 50/209

(57) ABSTRACT

A battery pack includes a plurality of battery cells, a housing, and an electrical component. The plurality of battery cells are arranged in a first direction. The housing accommodates the plurality of battery cells. The electrical component is electrically connected to at least one of the plurality of battery cells. The housing includes a bottom portion and a side wall portion. The plurality of battery cells are mounted on the bottom portion. The side wall portion is provided to rise from the bottom portion, a hollow portion being provided in the side wall portion. At least a portion of the electrical component is embedded in the side wall portion.

### CROSS REFERENCE TO RELATED APPLICATIONS

This nonprovisional application is based on Japanese Patent Application No. 2023-034424 filed on Mar. 7, 2023 with the Japan Patent Office, the entire contents of which are hereby incorporated by reference.

### BACKGROUND OF THE INVENTION

### Field of the Invention

The present technology relates to a battery pack.

### Description of the Background Art

Japanese National Patent Publication No. 2021-516187 is a prior art document that discloses a configuration of a battery pack. The battery pack described in Japanese National Patent Publication No. 2021-516187 includes a battery module, a framework, and a liquid cooling circuit. The framework accommodates and supports the battery module. The liquid cooling circuit includes one or more cooling plates that are in thermal contact with the battery module. The framework includes a first frame profile and a second frame profile disposed to face each other. Each of the first frame profile and the second frame profile is a portion of the liquid cooling circuit.

### SUMMARY OF THE INVENTION

In the battery pack described in Japanese National Patent Publication No. 2021-516187, since the cooling circuit is disposed inside a side wall portion of the housing, there is a possibility that the number of components can be reduced to reduce the size of the battery pack as compared with a case where the housing and the cooling circuit are separately provided. Thus, the battery pack has been required to be reduced in size in order to improve efficiency in mounting the battery pack on a vehicle or the like, and there is room for improvement in reduction in the size of the battery pack.

The present technology has been made to solve the above-described problem and has an object to provide a battery pack reduced in size.

The present technology provides the following battery pack.

[1]

A battery pack comprising:
a plurality of battery cells arranged in a first direction;
a housing that accommodates the plurality of battery cells; and
an electrical component electrically connected to at least one of the plurality of battery cells, wherein
the housing includes
   a bottom portion on which the plurality of battery cells are mounted, and
   a side wall portion provided to rise from the bottom portion, a hollow portion being provided in the side wall portion, and
at least a portion of the electrical component is embedded in the side wall portion.

[2]

The battery pack according to [1], wherein a whole of the electrical component is embedded in the side wall portion.

[3]

The battery pack according to [1] or [2], wherein
the side wall portion has a rib portion that partitions the hollow portion into a plurality of spaces, and
the electrical component is fixed to the rib portion.

[4]

The battery pack according to any one of [1] to [3], wherein
the side wall portion has a pair of first side wall portions and a pair of second side wall portions, the pair of first side wall portions sandwiching the plurality of battery cells in the first direction, the pair of second side wall portions connecting end portions of the pair of first side wall portions in a second direction orthogonal to the first direction, and
the electrical component is embedded in at least one of the pair of second side wall portions.

[5]

The battery pack according to any one of [1] to [4], wherein the electrical component is disposed in an outer side of the housing.

[6]

The battery pack according to any one of [1] to [4], wherein the electrical component is disposed in an inner side of the housing.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view showing a configuration of a battery pack according to a first embodiment of the present technology.

FIG. 2 is a perspective view showing a configuration of a battery cell according to the first embodiment of the present technology.

FIG. 3 is a cross sectional view of the battery pack of FIG. 1 when viewed in a direction of arrow of a line III-III.

FIG. 4 is a cross sectional view showing a method of connecting an electrical component to a side wall portion of a housing.

FIG. 5 is a cross sectional view showing a configuration of a battery pack according to a second embodiment of the present technology.

FIG. 6 is a cross sectional view showing a configuration of a battery pack according to a third embodiment of the present technology.

### DESCRIPTION OF THE PREFERRED EMBODIMENTS

Hereinafter, embodiments of the present technology will be described. It should be noted that the same or corresponding portions are denoted by the same reference characters, and may not be described repeatedly.

It should be noted that in the embodiments described below, when reference is made to number, amount, and the like, the scope of the present technology is not necessarily limited to the number, amount, and the like unless otherwise stated particularly. Further, in the embodiments described below, each component is not necessarily essential to the present technology unless otherwise stated particularly. Further, the present technology is not limited to one that necessarily exhibits all the functions and effects stated in the present embodiment.

It should be noted that in the present specification, the terms “comprise”, “include”, and “have” are open-end terms. That is, when a certain configuration is included, a configuration other than the foregoing configuration may or may not be included.

Also, in the present specification, when geometric terms and terms representing positional/directional relations are used, for example, when terms such as “parallel”, “orthogonal”, “obliquely at 45°”, “coaxial”, and “along” are used, these terms permit manufacturing errors or slight fluctuations. In the present specification, when terms representing relative positional relations such as “upper side” and “lower side” are used, each of these terms is used to indicate a relative positional relation in one state, and the relative positional relation may be reversed or turned at any angle in accordance with an installation direction of each mechanism (for example, the entire mechanism is reversed upside down).

In the present specification, the term “battery” is not limited to a lithium ion battery, and may include other batteries such as a nickel-metal hydride battery and a sodium ion battery. In the present specification, the term “electrode” may collectively represent a positive electrode and a negative electrode.

Further, the “battery pack” can be mounted on vehicles such as a hybrid electric vehicle (HEV), a plug-in hybrid electric vehicle (PHEV), and a battery electric vehicle (BEV). It should be noted that the use of the “battery pack” is not limited to the use in a vehicle.

It should be noted that in each of the figures, a Y direction serving as a first direction is defined to represent a direction in which a plurality of battery cells are arranged, an X direction serving as a second direction is defined to represent a direction in which a pair of second side wall portions of a housing are arranged, and a Z direction serving as a third direction is defined to represent a direction in which upper surface and bottom surface of each battery cell are arranged.

### First Embodiment

FIG. 1 is a perspective view showing a configuration of a battery pack according to a first embodiment of the present technology. As shown in FIG. 1, a battery pack 1 according to the first embodiment of the present technology includes a plurality of battery cells 100, a housing 200, and an electrical component 300.

The plurality of battery cells 100 are arranged along the first direction (Y direction). The plurality of battery cells 100 in the present embodiment are arranged along the first direction (Y direction) with each separator (not shown) being interposed between battery cells 100. Each of the separators is a plate having an insulating property.

Housing 200 accommodates the plurality of battery cells 100. Housing 200 is composed of aluminum or steel, for example. Housing 200 is formed by, for example, extrusion molding.

Housing 200 according to the present embodiment includes a bottom portion 210, a side wall portion 220, and a lid member (not shown).

The plurality of battery cells 100 are mounted on bottom portion 210. Side wall portion 220 is provided to rise from bottom portion 210. Bottom portion 210 and side wall portion 220 are joined together at a portion at which they are in contact with each other. Bottom portion 210 and side wall portion 220 in the present embodiment are adhered together by an adhesive agent. The lid member is provided to cover the plurality of battery cells 100 from above bottom portion 210 and side wall portion 220.

Side wall portion 220 has a pair of first side wall portions 230 and a pair of second side wall portions 240. The pair of first side wall portions 230 are disposed such that one first side wall portion 230a and the other first side wall portion 230b face each other. The pair of second side wall portions 240 are disposed such that one second side wall portion 240a and the other second side wall portion 240b face each other.

The pair of first side wall portions 230 sandwich the plurality of battery cells 100 in the first direction (Y direction). In the present embodiment, the plurality of battery cells 100 are sandwiched between one first side wall portion 230a and the other first side wall portion 230b.

The pair of second side wall portions 240 connect end portions of the pair of first side wall portions 230 in the second direction (X direction) orthogonal to the first direction (Y direction). In the present embodiment, the end portions of one first side wall portion 230a and the other first side wall portion 230b are connected together by one second side wall portion 240a and the other second side wall portion 240b. The pair of first side wall portions 230 and the pair of second side wall portions 240 are joined together by an adhesive agent.

Stacked battery cells 100 are inserted into housing 200 with a compressive force in the first direction (Y direction) being applied to stacked battery cells 100 and then the compressive force is released, with the result that a tensile force is applied to the pair of second side wall portions 240 that connect the pair of first side wall portions 230. As a reaction thereto, the pair of second side wall portions 240 press the pair of first side wall portions 230 in directions of bringing them closer to each other. As a result, housing 200 restrains the plurality of battery cells 100 in the first direction (Y direction).

As described above, in battery pack 1 of the present embodiment, the plurality of battery cells 100 are restrained and supported by such a structure (Cell-to-Pack structure) that side wall portion 220 of housing 200 directly supports the plurality of battery cells 100. It should be noted that battery pack 1 is not limited to having the Cell-to-Pack structure, and may have such a structure (Cell-Module-Pack structure) that a battery module including the plurality of battery cells 100 is accommodated in housing 200.

Electrical component 300 is electrically connected to at least one of the plurality of battery cells 100. Electrical component 300 in the present embodiment is, for example, a connector that electrically connects the inside and outside of housing 200. Details of electrical component 300 will be described later.

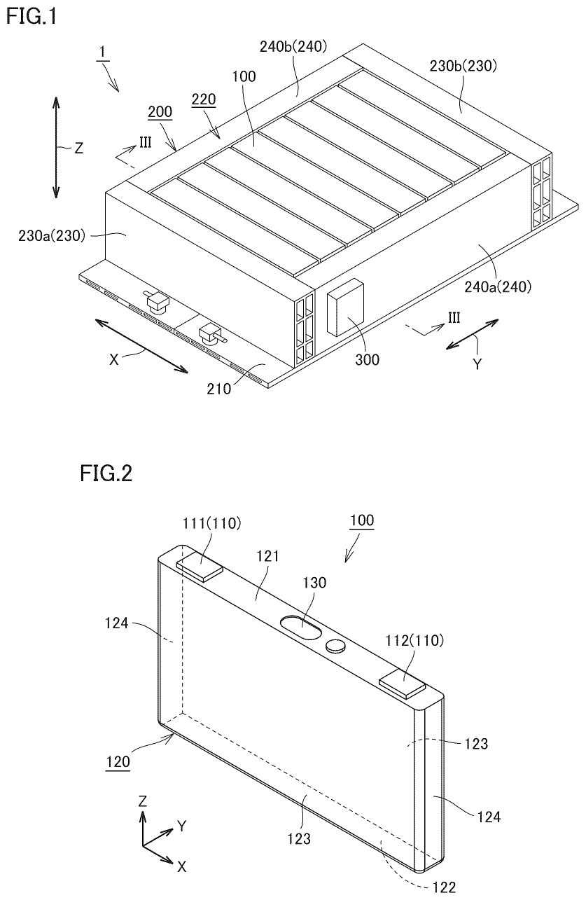

FIG. 2 is a perspective view showing a configuration of a battery cell according to the first embodiment of the present technology. As shown in FIG. 2, battery cell 100 is, for example, a lithium ion battery. Battery cell 100 has a prismatic shape.

Each of the plurality of battery cells 100 includes electrode terminals 110, case body 120, and a gas-discharge valve 130.

Electrode terminals 110 have a positive electrode terminal 111 and a negative electrode terminal 112. Electrode terminals 110 are formed on case body 120.

Case body 120 is a container that accommodates an electrode assembly (not shown) and an electrolyte solution (not shown). Case body 120 has a substantially rectangular parallelepiped shape. Case body 120 is composed of aluminum, an aluminum alloy, iron, an iron alloy, or the like.

Case body 120 has an upper surface 121, a lower surface 122, a pair of long side surfaces 123, and a pair of short side surfaces 124.

Electrode terminals 110 are disposed on upper surface 121. Lower surface 122 is opposite to upper surface 121 in the third direction (Z direction).

The pair of long side surfaces 123 and the pair of short side surfaces 124 constitute side surfaces of case body 120. The pair of long side surfaces 123 and the pair of short side surfaces 124 serving as the side surfaces of case body 120 intersect each of upper surface 121 and lower surface 122. The pair of long side surfaces 123 are opposite to each other in the first direction (Y direction). The pair of short side surfaces 124 are opposite to each other in the second direction (X direction). Each of the pair of long side surfaces 123 has a larger area than that of each of the pair of short side surfaces 124.

Gas-discharge valve 130 is fractured when pressure inside case body 120 becomes equal to or more than a predetermined value. Thus, gas in case body 120 is discharged to outside of case body 120.

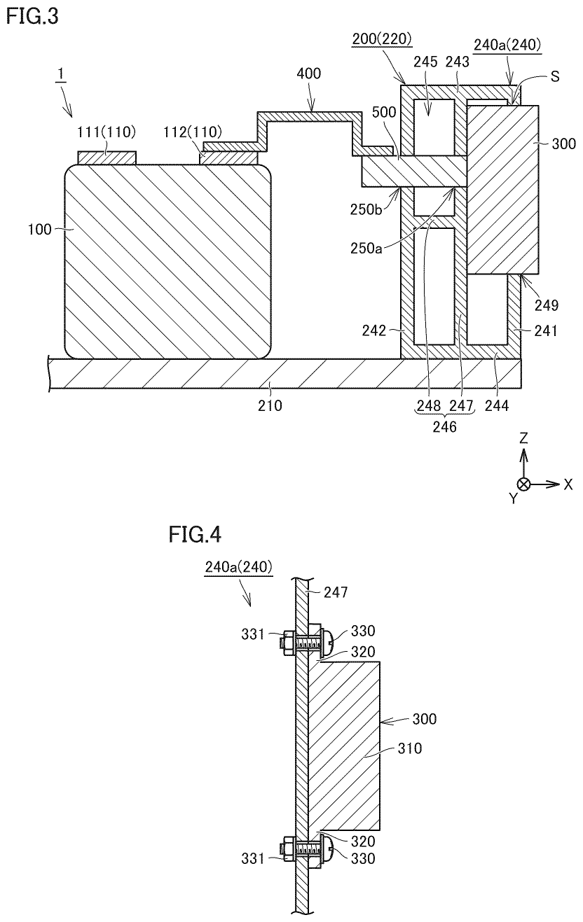

FIG. 3 is a cross sectional view of the battery pack of FIG. 1 when viewed in a direction of arrow of a line III-III. As shown in FIG. 3, battery pack 1 according to the present embodiment further includes a bus bar 400 and a wiring member 500.

Bus bar 400 electrically connects the plurality of battery cells 100 together or electrically connects battery cell 100 to wiring member 500. One side of bus bar 400 shown in FIG. 3 is connected to electrode terminal 110, and the other side thereof extends to and is connected to wiring member 500.

One side of wiring member 500 is connected to the other side of bus bar 400, and the other side thereof is connected to electrical component 300. Wiring member 500 is, for example, a conductive wire covered with an insulating coating (not shown).

Wiring member 500 according to the present embodiment has flexibility and can be bent in various directions. Therefore, if wiring member 500 is disposed in battery pack 1, wiring member 500 can be bent in any direction, with the result that wiring member 500 is less likely to be a component that determines the size of the outer shape of battery pack 1.

On the other hand, electrical component 300 is a component such as a connector, and it is therefore difficult to bend electrical component 300. Therefore, when electrical component 300 is disposed in battery pack 1, electrical component 300 is highly likely to be a component that determines the size of the outer shape of battery pack 1. Thus, electrical component 300 and wiring member 500 according to the present embodiment are different from each other in terms of a degree of influence over the size of the outer shape of battery pack 1.

One second side wall portion 240a has an outer side wall portion 241, an inner side wall portion 242, an upper side wall portion 243, a lower side wall portion 244, and a rib portion 246. A hollow portion 245 is provided in a portion surrounded by outer side wall portion 241, inner side wall portion 242, upper side wall portion 243, and lower side wall portion 244. It should be noted that the other second side wall portion 240b may have the same structure as that of one second side wall portion 240a.

Outer side wall portion 241 and inner side wall portion 242 face each other in the X direction. Upper side wall portion 243 and lower side wall portion 244 face each other in the Z direction. Both ends of outer side wall portion 241 and inner side wall portion 242 in the Z direction are connected by upper side wall portion 243 and lower side wall portion 244.

Rib portion 246 is provided to secure member strength in side wall portion 220 provided with hollow portion 245 for the purpose of weight reduction or the like. Rib portion 246 partitions hollow portion 245 into a plurality of spaces. Rib portion 246 partitions hollow portion 245 into four spaces when viewed in the first direction (Y direction).

Rib portion 246 has a first rib 247 and a second rib 248. First rib 247 is a portion extending in the third direction (Z direction). Second rib 248 is a portion extending in the second direction (X direction). First rib 247 and second rib 248 intersect each other in the vicinity of the center of hollow portion 245.

First rib 247 is provided with a through hole 250a. Second rib 248 is provided with a through hole 250b. Wiring member 500 is inserted into through holes 250a, 250b.

Outer side wall portion 241 is provided with an opening 249. In one second side wall portion 240a, an inner space S for disposing electrical component 300 therein is formed. Opening 249 and inner space S are formed by cutting or the like.

At least a portion of electrical component 300 is embedded in side wall portion 220. Electrical component 300 is disposed in the outer side of housing 200. Electrical component 300 is connected to a driving device or the like external to battery pack 1 by a cable (not shown) or the like. Since the portion of electrical component 300 is embedded in side wall portion 220, electrical component 300 is suppressed from protruding outward from housing 200 as compared with a case where electrical component 300 is disposed adjacent to the surface of side wall portion 220.

Since inner space S is formed in side wall portion 220 in which electrical component 300 is embedded, the strength of side wall portion 220 at its portion around inner space S may be decreased. In the present embodiment, since battery pack 1 has the Cell-to-Pack structure, the pair of first side wall portions 230 of side wall portions 220 directly receive a pressing force caused by expansion of the plurality of battery cells 100. Therefore, in the present embodiment, at least the portion of electrical component 300 is embedded in one second side wall portion 240a. Thus, second side wall portion 240a, which may have strength decreased due to the formation of inner space S, in side wall portion 220 can be less likely to receive the pressing force from the plurality of battery cells 100. As a result, electrical component 300 can be embedded in side wall portion 220 without decreasing the restraint force of housing 200 on the plurality of battery cells 100. It should be noted that electrical component 300 may be embedded in the other second side wall portion 240b. Further, electrical component 300 may be embedded in each of the pair of first side wall portions 230 in consideration of the strength of side wall portion 220 provided with inner space S.

It should be noted that electrical component 300 may be disposed only in one space partitioned by rib portion 246 of hollow portion 245. Thus, even if water is splashed onto battery pack 1, intrusion of water into the inside of battery pack 1 can be prevented only at the space.

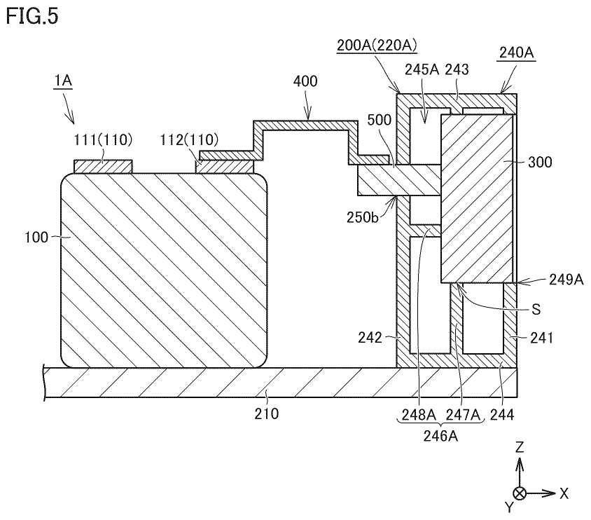

FIG. 4 is a cross sectional view showing a method of connecting the electrical component to the side wall portion of the housing. As shown in FIG. 4, electrical component 300 has a flange portion 320 extending from a main body portion 310.

A bolt 330 is inserted into flange portion 320. A nut 331 is disposed on a side of first rib 247 opposite to the side on which electrical component 300 is disposed. Bolt 330 and nut 331 are screwed together with bolt 330 being inserted in flange portion 320. Thus, electrical component 300 is fixed to first rib 247.

When electrical component 300 is fixed to first rib 247, opening 249 is provided in outer side wall portion 241. Therefore, when providing opening 249 by machining, the machining can be performed to form opening 249 in the same direction (X direction) as the direction of each of through holes 250a, 250b. This leads to improved machining efficiency for each of through holes 250a, 250b, opening 249, and inner space S.

It should be noted that the fixation of electrical component 300 to first rib 247 is not limited to the fixation by bolt 330 and nut 331. The method of fixing electrical component 300 to first rib 247 may be any fixing method such as a method of using a welded nut, a method of using an insert nut, a method of providing female threading in first rib 247, a method of using a swaged nut, a method of using a welded stud bolt, or a method of fixing using a rivet.

Further, electrical component 300 is not limited to being fixed to first rib 247, and may be fixed to second rib 248. When fixing electrical component 300 to second rib 248, the height of electrical component 300 in the Z direction can be low with the longitudinal direction of electrical component 300 being along second rib 248, and this is effective in lowering the height of battery pack 1.

In battery pack 1 according to the first embodiment of the present technology, since at least the portion of electrical component 300 is embedded in side wall portion 220, the size of battery pack 1 can be reduced as compared with a case where electrical component 300 is disposed adjacent to the surface of side wall portion 220.

In battery pack 1 according to the first embodiment of the present technology, since electrical component 300 is fixed to rib portion 246, electrical component 300 can be stably fixed to side wall portion 220.

In battery pack 1 according to the first embodiment of the present technology, since electrical component 300 is embedded in one second side wall portion 240a, the strength of each of the pair of first side wall portions 230 that receive the pressing force caused by expansion of the plurality of battery cells 100 can be suppressed from being decreased and the size of battery pack 1 can be reduced with electrical component 300 being embedded in one second side wall portion 240a.

In battery pack 1 according to the first embodiment of the present technology, since a distance between electrical component 300 and each of the plurality of battery cells 100 is shorter than that in the case where electrical component 300 is disposed adjacent to the outer surface of housing 200, cost of wiring member 500 that connects them can be reduced and a vibration characteristic can be improved.

### Second Embodiment

Hereinafter, a battery pack according to a second embodiment of the present technology will be described. Since the configuration of a housing of the battery pack according to the second embodiment is different from that of battery pack 1 according to the first embodiment of the present technology, the same configuration as that of battery pack 1 according to the first embodiment of the present technology will not be described repeatedly.

FIG. 5 is a cross sectional view showing a configuration of a battery pack according to a second embodiment of the present technology. As shown in FIG. 5, a housing 200A included in a battery pack 1A according to the second embodiment includes a side wall portion 220A. Side wall portion 220A has one second side wall portion 240A.

One second side wall portion 240A has an outer side wall portion 241, an inner side wall portion 242, an upper side wall portion 243, a lower side wall portion 244 and a rib portion 246A. A hollow portion 245A is provided in a portion surrounded by outer side wall portion 241, inner side wall portion 242, upper side wall portion 243, and lower side wall portion 244. The other second side wall portion may have the same structure as that of one second side wall portion 240A.

Rib portion 246A has a first rib 247A and a second rib 248A. First rib 247A is a portion extending in the third direction (Z direction). Second rib 248A is a portion extending in the second direction (X direction).

Outer side wall portion 241 is provided with an opening 249A. In one second side wall portion 240A, an inner space S for disposing electrical component 300 therein is formed.

A whole of electrical component 300 is embedded in side wall portion 220A. In the present embodiment, the whole of electrical component 300 is embedded in one second side wall portion 240A. Electrical component 300 does not protrude from outer side wall portion 241 to the outside of housing 200A.

In battery pack 1A according to the second embodiment of the present technology, since the whole of electrical component 300 is embedded in second side wall portion 240A, the size of battery pack 1 can be reduced as compared with the case where electrical component 300 is partially embedded in side wall portion 220 in the first embodiment. Further, when water is splashed onto electrical component 300, the water is less likely to be splashed onto electrical component 300 than in the case where electrical component 300 is disposed adjacent to the surface of side wall portion 220A, thus resulting in improved waterproofness of electrical component 300.

### Third Embodiment

Hereinafter, a battery pack according to a third embodiment of the present technology will be described. Since the position of the electrical component in the battery pack according to the third embodiment is different from that in battery pack 1 according to the first embodiment of the present technology, the same configuration as that of battery pack 1 according to the first embodiment of the present technology will not be described repeatedly.

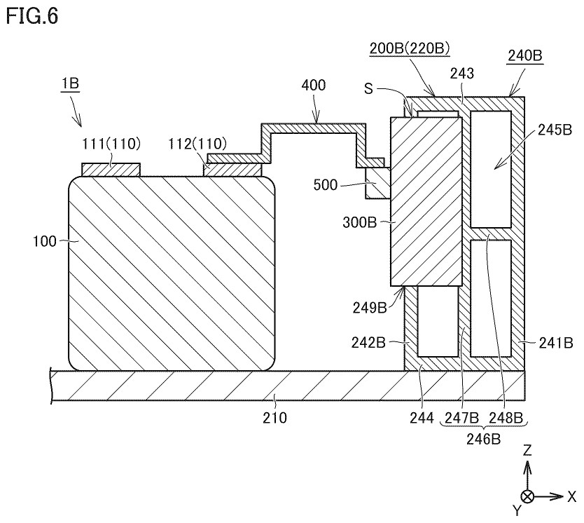

FIG. 6 is a cross sectional view showing a configuration of a battery pack according to a third embodiment of the present technology. As shown in FIG. 6, a housing 200B included in a battery pack 1B according to the third embodiment includes a side wall portion 220B. Side wall portion 220B has one second side wall portion 240B.

One second side wall portion 240B has an outer side wall portion 241B, an inner side wall portion 242B, an upper side wall portion 243, a lower side wall portion 244 and a rib portion 246B. A hollow portion 245B is provided in a portion surrounded by outer side wall portion 241B, inner side wall portion 242B, upper side wall portion 243, and lower side wall portion 244. The other second side wall portion may have the same structure as that of one second side wall portion 240B.

Rib portion 246B has a first rib 247B and a second rib 248B. First rib 247B is a portion extending in the third direction (Z direction). Second rib 248B is a portion extending in the second direction (X direction).

Inner side wall portion 242B is provided with an opening 249B. An inner space S for disposing electrical component 300B therein is formed in one second side wall portion 240B.

Electrical component 300B is disposed in the inner side of housing 200B. Electrical component 300B in the present embodiment is, for example, a junction box. It should be noted that electrical component 300B is not limited to the junction box, and may be a terminal block or a DC/DC converter.

In battery pack 1B according to the third embodiment of the present technology, a portion of electrical component 300B covered with side wall portion 220B of housing 200B is larger than that in the case where electrical component 300B is disposed adjacent to the inner surface of housing 200B, thereby suppressing application of shock on electrical component 300B while reducing the size of battery pack 1B.

It should be noted that the hollow portion is provided in the side wall portion in each of the above-described embodiments; however, it is not limited to the embodiment and the hollow portion may not be provided in the side wall portion.

Although the embodiments of the present invention have been described and illustrated in detail, it is clearly understood that the same is by way of illustration and example only and is not to be taken by way of limitation. The scope of the present invention is defined by the terms of the claims, and is intended to include any modifications within the scope and meaning equivalent to the terms of the claims.

What is claimed is:

1. A battery pack comprising:
a plurality of battery cells arranged in a first direction;
a housing that accommodates the plurality of battery cells; and
an electrical component electrically connected to at least one of the plurality of battery cells, wherein
the housing includes
a bottom portion on which the plurality of battery cells are mounted, and
a side wall portion provided to rise from the bottom portion, a hollow portion being provided in the side wall portion, and
at least a portion of the electrical component is embedded in the side wall portion.

2. The battery pack according to claim 1, wherein a whole of the electrical component is embedded in the side wall portion.

3. The battery pack according to claim 1, wherein
the side wall portion has a rib portion that partitions the hollow portion into a plurality of spaces, and
the electrical component is fixed to the rib portion.

4. The battery pack according to claim 2, wherein
the side wall portion has a rib portion that partitions the hollow portion into a plurality of spaces, and
the electrical component is fixed to the rib portion.

5. The battery pack according to claim 1, wherein
the side wall portion has a pair of first side wall portions and a pair of second side wall portions, the pair of first side wall portions sandwiching the plurality of battery cells in the first direction, the pair of second side wall portions connecting end portions of the pair of first side wall portions in a second direction orthogonal to the first direction, and
the electrical component is embedded in at least one of the pair of second side wall portions.

6. The battery pack according to claim 2, wherein
the side wall portion has a pair of first side wall portions and a pair of second side wall portions, the pair of first side wall portions sandwiching the plurality of battery cells in the first direction, the pair of second side wall portions connecting end portions of the pair of first side wall portions in a second direction orthogonal to the first direction, and
the electrical component is embedded in at least one of the pair of second side wall portions.

7. The battery pack according to claim 1, wherein the electrical component is disposed in an outer side of the housing.

8. The battery pack according to claim 2, wherein the electrical component is disposed in an outer side of the housing.

9. The battery pack according to claim 1, wherein the electrical component is disposed in an inner side of the housing.

10. The battery pack according to claim 2, wherein the electrical component is disposed in an inner side of the housing.
